(19) United States
(12) Patent Application Publication
(10) Pub. No.: US 2013/0224569 A1
(43) Pub. Date: Aug. 29, 2013

(54) METAL OXYGEN BATTERY

(71) Applicants: Hiroshi SAKAI, Saitama (JP); Kiyoshi TANAAMI, Saitama (JP); Kazuki SAIMEN, Saitama (JP); Akihisa TANAKA, Saitama (JP); Takuya TANIUCHI, Saitama (JP); Satoshi NAKADA, Saitama (JP); Mao HORI, Saitama (JP); Tomohiro KINOSHITA, Saitama (JP); Bunichi SAITO, Saitama (JP); Masahiro TAKAHATA, Saitama (JP)

(72) Inventors: Hiroshi SAKAI, Saitama (JP); Kiyoshi TANAAMI, Saitama (JP); Kazuki SAIMEN, Saitama (JP); Akihisa TANAKA, Saitama (JP); Takuya TANIUCHI, Saitama (JP); Satoshi NAKADA, Saitama (JP); Mao HORI, Saitama (JP); Tomohiro KINOSHITA, Saitama (JP); Bunichi SAITO, Saitama (JP); Masahiro TAKAHATA, Saitama (JP)

(73) Assignee: HONDA MOTOR CO., LTD., Tokyo (JP)

(21) Appl. No.: 13/779,805

(22) Filed: Feb. 28, 2013

(30) Foreign Application Priority Data
Feb. 29, 2012 (JP) 2012-044410

(51) Int. Cl. H01M 2/02

(52) U.S. Cl. CPC H01M 2/02
USPC 429/163

(57) ABSTRACT

Provided is a metal oxygen battery having an excellent charge/discharge capacity and cycle performance. A metal oxygen battery includes a positive electrode containing an oxygen-storing material and to which oxygen is applied as an active substance, a negative electrode to which a metal is applied as an active substance, an electrolyte layer disposed between the positive electrode and the negative electrode, and a case hermetically housing the positive electrode, the negative electrode and the electrolyte layer. The oxygen-storing material has the functions of, during discharge, ionizing stored oxygen and releasing ionized oxygen, and causing the ionized oxygen to react with metal ions permeating from the negative electrode through the electrolyte layer into the positive electrode to thereby form a metal oxide, and of, during charge, storing oxygen by reduction of the metal oxide. The metal oxide formed during discharge contains an amorphous oxide.

### CROSS-REFERENCE TO RELATED APPLICATIONS

This application is based upon and claims the benefit of priority from Japanese Patent Application No. 2012-04410 filed on Feb. 29, 2012, the contents of which are incorporated herein by reference.

### BACKGROUND OF THE INVENTION

1. Field of the Invention

The present invention relates to a metal oxygen battery.

2. Description of the Related Art

Metal oxygen batteries are conventionally known which comprise a positive electrode using oxygen as an active substance, a negative electrode using a metal such as zinc or lithium as an active substance, and an electrolyte layer interposed between the positive electrode and the negative electrode (see, for example, Japanese Patent Laid-Open No. 2008-181853).

In the metal oxygen batteries, the positive electrode, the negative electrode, and the electrolyte layer are housed in a case; and the positive electrode is opened to the atmosphere through a microporous membrane provided in the case. Then, in the metal oxygen batteries, oxygen introduced from the air can be made to act as an active substance in the positive electrode, and the energy density can be anticipated to be improved.

In the metal oxygen batteries, generally during discharge, a cell reaction occurs in which while a metal such as zinc or lithium is oxidized at the negative electrode to form metal ions, oxygen is reduced at the positive electrode to form oxygen ions. The metal ions formed at the negative electrode permeate the electrolyte layer and migrate to the positive electrode, and bind to the oxygen ions to thereby form a metal oxide. During charge, the reverse reactions of the respective cell reactions are caused in the negative electrode and the positive electrode. Consequently, charge and discharge by the cell reactions are carried out.

However, in metal oxygen batteries in which the positive electrode is opened to the atmosphere, disadvantages arise that a sufficient charge/discharge capacity cannot be acquired and in the case of repeating charge and discharge, the decrease in the charge/discharge capacity is remarkable and a sufficient cycle performance cannot be acquired in some cases.

### SUMMARY OF THE INVENTION

Then, an object of the present invention is to eliminate such disadvantages and provide a metal oxygen battery having an excellent charge/discharge capacity and cycle performance.

The cell reaction at the positive electrode is conceivably caused in the interface (hereinafter, abbreviated to a three-phase interface) among three phases, which are oxygen as an active substance, ions of the metal constituting the negative electrode and electrons. It is reported that a problem of a metal oxygen battery in which the positive electrode is opened to the atmosphere is that the particle of a metal oxide depositing by the cell reaction during discharge is about 10 μm, which is coarse with respect to the three-phase interface, and the deposition of the metal oxide breaks the three-phase interface, resulting in deterioration in the cell performance (the 52nd Proceedings of Batteriesymposium in Japan 4D02).

In order to reduce thoroughly the coarse metal oxide as described above by the cell reaction during charge, an overvoltage is also conceivably generated. The case where a part of the metal oxide is not reduced by the cell reaction during charge and remains also conceivably makes a cause of an irreversible capacity.

Here, it is conceivable that since the positive electrode is opened to the atmosphere and present in an environment abundant in oxygen, the metal oxide crystallizes and forms a coarse particle as described above.

Then, the present invention, in order to achieve such an object, is a metal oxygen battery including a positive electrode containing an oxygen-storing material and to which oxygen is applied as an active substance, a negative electrode to which a metal is applied as an active substance, an electrolyte layer disposed between the positive electrode and the negative electrode, and a case hermetically housing the positive electrode, the negative electrode and the electrolyte layer, wherein the oxygen-storing material has the functions of, during discharge, ionizing stored oxygen and releasing ionized oxygen, and causing the ionized oxygen to react with metal ions permeating from the negative electrode through the electrolyte layer into the positive electrode to thereby form a metal oxide, and of, during charge, storing oxygen formed by reduction of the metal oxide; and when during discharge, the oxygen-storing material ionizes stored oxygen and releases ionized oxygen, and causes the ionized oxygen to react with metal ions permeating from the negative electrode through the electrolyte layer into the positive electrode to thereby form a metal oxide, the metal oxide comprises an amorphous.

In the metal oxygen battery according to the present invention, the positive electrode, the negative electrode and the electrolyte layer are hermetically housed in the case; and during discharge, the oxygen-storing material contained in the positive electrode ionizes stored oxygen and releases the ionized oxygen. In the positive electrode, the oxygen ions bind to metal ions permeating from the negative electrode through the electrolyte layer into the positive electrode to thereby form a metal oxide. On the other hand, during charge, the oxygen-storing material stores oxygen formed by reduction of the metal oxide.

In the metal oxygen battery according to the present invention, since the positive electrode, the negative electrode and the electrolyte layer are hermetically housed in the case, when a metal oxide is formed in the positive electrode during discharge, the oxygen present in the positive electrode is only oxygen released from the oxygen-storing material. Therefore, it is conceivable that the crystallization of the metal oxide formed in the positive electrode is suppressed and the metal oxide becomes a metal oxide containing an amorphous.

Consequently, according to the metal oxygen battery according to the present invention, the metal oxide containing an amorphous can easily be reduced during charge, thus suppressing the generation of the overvoltage and providing an excellent charge/discharge capacity. Further according to the metal oxygen battery according to the present invention, since the metal oxide containing an amorphous can easily be reduced during charge, the generation of an irreversible capacity due to the metal oxide remaining without being reduced is suppressed, thus providing an excellent cycle performance.

In the present application, “amorphous” refers to a metal oxide in which no peak originated from the metal oxide is clearly detected by X-ray diffractometry, but which is detected as a metal oxide by another analysis unit such as Raman spectrometry, infrared spectrophotometry (IR) or nuclear magnetic resonance spectrometry (NMR).

In the metal oxygen battery according to the present invention, the oxygen-storing material is a material capable of occluding/releasing oxygen, and capable of adsorbing/desorbing oxygen on/from the surface. Since oxygen adsorbed/desorbed on/from the surface of the oxygen-storing material does not need to be diffused in the oxygen-storing material in order to be occluded/released in/from the oxygen-storing material, the oxygen results in being used for the cell reaction in a lower energy and can act more advantageously than oxygen occluded/released.

In the metal oxygen battery according to the present invention, the oxygen-storing material preferably has a catalytic function for the cell reaction. That the oxygen-storing material has the catalytic function allows easy formation of the metal oxide and reduction of the metal oxide in the positive electrode.

In the metal oxygen battery according to the present invention, as the oxygen-storing material, a composite metal oxide can be used. The composite metal oxide can be in the range of 5 to 95% by mass of the whole of the positive electrode.

In the metal oxygen battery according to the present invention, for the positive electrode, a material having an electron conductivity itself may be used as the oxygen-storing material, but a constitution may be used which comprises the oxygen-storing material and a conductive auxiliary having an electron conductivity.

In the metal oxygen battery according to the present invention, at the positive electrode, the metal oxide is formed during discharge, and the metal oxide is reduced to thereby form oxygen during charge. Therefore, the positive electrode preferably comprises a porous body having a porosity of 10 to 90% by volume in order to accommodate the metal oxide and oxygen.

The positive electrode, with the porosity lower than 10% by volume, cannot sufficiently accommodate the metal oxide and oxygen, and cannot provide a desired electromotive force in some cases. The positive electrode, with the porosity exceeding 90% by volume, exhibits insufficient strength in some cases.

In the metal oxygen battery according to the present invention, the negative electrode preferably comprises one metal selected from the group consisting of Li, Zn, Al, Mg, Fe, Ca, Na and K, an alloy thereof, an organometallic compound containing the metal or an organic complex of the metal. Any of the metal, the alloy, the organometallic compound and the organic complex acts as an active substance in the negative electrode.

### BRIEF DESCRIPTION OF THE DRAWINGS

FIG. 1 is an illustrative cross-sectional diagram showing one constitution example of the metal oxygen battery according to the present invention;

FIG. 2 is a graph showing X-ray diffraction patterns before and after discharge in a positive electrode of the metal oxygen battery according to the present invention using a composite metal oxide represented by the chemical formula YMnO₃ as an oxygen-storing material;

FIG. 3 is a graph showing a measurement result by a nuclear magnetic resonance spectroscopy after discharge in the positive electrode of the metal oxygen battery according to the present invention using the composite metal oxide represented by the chemical formula YMnO₃ as the oxygen-storing material;

FIG. 4 is a graph showing relationships between the cell voltage and the capacity during discharge of the metal oxygen batteries according to the present invention using various types of oxygen-storing materials;

FIG. 5 is a graph showing relationships between the cell voltage and the capacity during charge of the metal oxygen batteries according to the present invention using various types of oxygen-storing materials;

FIG. 6 is a graph showing relationships between the cell voltage and the capacity in the charge and the discharge time of the metal oxygen battery according to the present invention using a composite metal oxide represented by the chemical formula (Gd_{0.7}Y_{0.26}Ba_{0.04})₂O₃ as the oxygen-storing material;

FIG. 7 is a graph showing cycle performances using relationships between the cell voltage and the capacity in the charge and the discharge time of the metal oxygen battery according to the present invention using the composite metal oxide represented by the chemical formula Y_{0.9}Ag_{0.1}MnO₃ as the oxygen-storing material;

FIG. 8 is an illustrative cross-sectional diagram showing one constitution example of a conventional metal oxygen battery;

FIG. 9 is a graph showing an X-ray diffraction pattern after discharge in the positive electrode of a conventional metal oxygen battery;

FIG. 10 is a graph showing relationships between the cell voltage and the capacity during discharge of the metal oxygen battery according to the present invention using metallic zinc for the negative electrode;

FIG. 11 is a graph showing relationships between the cell voltage and the capacity during discharge of the metal oxygen battery according to the present invention using metallic iron for the negative electrode;

FIG. 12 is a graph showing relationships between the cell voltage and the capacity during discharge of the metal oxygen battery according to the present invention using a Li—In alloy or Si having Li ions intercalated therein in advance for the negative electrode;

FIG. 13 is a graph showing relationships between the cell voltage and the capacity during charge of the metal oxygen battery according to the present invention using a Li—In alloy or Si having Li ions intercalated therein in advance for the negative electrode;

FIG. 14 is a graph showing relationships between the cell voltage and the capacity during discharge of the metal oxygen battery according to the present invention using Li₄Ti₅O₁₂ for the negative electrode;

FIG. 15 is a graph showing relationships between the cell voltage and the capacity during charge of the metal oxygen battery according to the present invention using Li₄Ti₅O₁₂ for the negative electrode;

FIG. 16 is a graph showing relationships between the cell voltage and the capacity in the charge and the discharge time of the metal oxygen battery according to the present invention using metallic sodium for the negative electrode;

FIG. 17 is a graph showing relationships between the cell voltage and the capacity during discharge of the metal oxygen batteries according to the present invention the porosity of whose positive electrode is varied;

FIG. 18 is a graph showing relationships between the cell voltage and the capacity during charge of the metal oxygen batteries according to the present invention the porosity of whose positive electrode is varied;

FIG. 19 is a graph showing relationships between the cell voltage and the capacity during discharge of the metal oxygen batteries according to the present invention which use YMnO₃, the amount of which is varied, as an oxygen-storing material;

FIG. 20 is a graph showing relationships between the cell voltage and the capacity during charge of the metal oxygen batteries according to the present invention which use YMnO₃, the amount of which is varied, as an oxygen-storing material;

FIG. 21 is a graph showing relationships between the cell voltage and the capacity during discharge of the metal oxygen batteries according to the present invention using various types of nonaqueous solvents as a solvent for an electrolyte solution; and

FIG. 22 is a graph showing relationships between the cell voltage and the capacity during charge of the metal oxygen batteries according to the present invention using various types of nonaqueous solvents as a solvent for an electrolyte solution.

### DETAILED DESCRIPTION OF THE PREFERRED EMBODIMENTS

Then, the embodiments according to the present invention will be described in more detail by way of accompanying drawings.

As shown in FIG. 1, a metal oxygen battery 1 according to the present embodiment comprises a positive electrode 2 to which oxygen is applied as an active substance, a negative electrode 3 to which a metal is applied as an active substance, and an electrolyte layer 4 disposed between the positive electrode 2 and the negative electrode 3; and the positive electrode 2, the negative electrode 3 and the electrolyte layer 4 are hermetically housed in a case 5.

The case 5 comprises a cup-form case body 6 and a lid body 7 to cover the case body 6; and an insulating resin 8 is interposed between the case body 6 and the lid body 7. The positive electrode 2 has a positive electrode current collector 9 between the positive electrode 2 and the top surface of the lid body 7; and the negative electrode 3 has a negative electrode current collector 10 between the negative electrode 3 and the bottom surface of the case body 6.

In the metal oxygen battery 1, the positive electrode 2 contains an oxygen-storing material. The oxygen-storing material is a material having a catalytic function for the cell reaction in the positive electrode 2, and having the functions of, during discharge, ionizing oxygen, binding the ionized oxygen with metal ions migrating from the negative electrode 3 through the electrolyte layer 4 to the positive electrode 2 to form a metal oxide, and during charge, reducing the metal oxide, and storing oxygen.

Such an oxygen-storing material usable is, for example, a metal oxide or a composite metal oxide having any structure of the hexagonal structure, the C-rare earth structure, the apatite structure, the delafossite structure, the fluorite structure, the perovskite structure, the cubic structure and the rhombic structure.

Examples of the composite metal oxide having the hexagonal structure include YMnO₃. Examples of the composite metal oxide having the C-rare earth structure include (Gd_{0.70}Y_{0.26}Ba_{0.04})O_{2.96}. Examples of the composite metal oxide having the apatite structure include La_{9.33}Si₆O₂₆ and La_{8.33}SrSiO_{25.5}.

Examples of the composite metal oxide having the delafossite structure include CuFeO₂, CuAlO₂, CuCrO₂ and CuYO₂. Examples of the metal oxide having the fluorite structure include ZrO₂ and CeO₂. Examples of the composite metal oxide having the perovskite structure include LaMnO₃, SrMnO₃ and SrFeO₃.

Examples of the composite metal oxide having the cubic structure include (Gd_{0.7}Y_{0.26}Ba_{0.04})₂O₃; and examples of the composite metal oxide having the rhombic structure include Y_{0.9}Ag_{0.1}MnO₃.

The composite metal oxide, in order to act as the oxygen-storing material, has preferably an oxygen storing/releasing capability of 100 mmol or more of oxygen, and preferably 500 mmol or more, per 1 mol of the composite metal oxide. The oxygen storing/releasing capability of the composite metal oxide can be evaluated, for example, by a temperature programmed desorption (TPD) measurement.

The composite metal oxide has, as a catalytic function for the cell reaction, preferably an average overvoltage ΔV during discharge of 1.1 V or lower, and more preferably 0.7 V or lower. The composite metal oxide has, as a catalytic function for the cell reaction, preferably an average overvoltage ΔV during charge of 1.5 V or lower, and more preferably 1.1 V or lower.

The positive electrode 2 has preferably an electron conductivity of 10⁻⁷ S/m or higher, and more preferably 1.0 S/m or higher.

The composite metal oxide can be, for example, in the range of 5 to 95% by mass of the whole of the positive electrode 2.

For the positive electrode 2, in order to have an electron conductivity in the above range, a material having an electron conductivity itself may be used as the oxygen-storing material, but a constitution may be used which comprises the oxygen-storing material and a conductive auxiliary having an electron conductivity. The positive electrode 2, in the case of containing the oxygen-storing material and the conductive auxiliary, further contains a binder to bind these.

Examples of the conductive auxiliary include carbonaceous materials such as graphite, acetylene black, Ketjen black, carbon nanotubes, mesoporous carbon and carbon fibers. Examples of the binder include polytetrafluoroethylene (PTFE) and polyvinylidene fluoride (PVDF).

The positive electrode 2 preferably comprises a porous body having a porosity of 10 to 90% by volume, in order to accommodate a metal oxide being a reaction product of oxygen which the oxygen-storing material ionizes during discharge, and oxygen which the oxygen-storing material releases by the reduction of the metal oxide during charge.

In the metal oxygen battery 1, the negative electrode 3 contains one metal selected from the group consisting of Li, Zn, Al, Mg, Fe, Ca, Na and K, an alloy thereof, an organometallic compound containing the metal, an organic complex of the metal, or a Si having ions of the metal intercalated therein in advance.

Examples of the alloy of the metal include a Li—In alloy, a Li—Al alloy, a Li—Mg alloy and a Li—Ca alloy. Examples of the organometallic compound containing the metal include Li₂₂Si₅ and Li₄Ti₅O₁₂. Examples of the Si having ions of the metal intercalated therein in advance include a Si having Li ions intercalated therein in advance.

In the metal oxygen battery 1, the electrolyte layer 4 comprises, for example, an electrolyte solution comprising a KOH solution, or a separator which is impregnated with an electrolyte solution in which a salt of a metal used in the negative electrode 3 is dissolved in a nonaqueous solvent.

Examples of the nonaqueous solvent include a carbonate-based solvent, an etheric solvent and an ionic liquid. Examples of the carbonate-based solvent include ethylene carbonate, propylene carbonate, dimethyl carbonate and diethyl carbonate.

The carbonate-based solvent may be used singly or as a mixture of two or more. As the carbonate-based solvent, for example, propylene carbonate may be used singly; a mixed solution of 30 to 70 parts by mass of propylene carbonate and 30 to 70 parts by mass of dimethyl carbonate or diethyl carbonate may be used; and a mixed solution of 30 to 70 parts by mass of ethylene carbonate and 30 to 70 parts by mass of dimethyl carbonate or diethyl carbonate may be used.

Examples of the etheric solvent include dimethoxyethane, dimethyltriglyme and polyethylene glycol. The etheric solvent may be used singly or as a mixture of two or more.

The ionic liquid is a salt of a cation and an anion, which is in the melt state at normal temperature. Examples of the cation include imidazolium, ammonium, pyridinium and piperidinium. Examples of the anion include bis(trifluoromethylsulfonyl)imide (TTSI), bis(pentafluoroethylsulfonyl)imide (BETI), tetrafluoroborate, perchlorate and a halogen anion.

Examples of the separator include glass fibers, glass papers, polypropylene-made nonwoven fabrics, polyimide-made nonwoven fabrics, polyphenylene sulfide-made nonwoven fabrics and polyethylene porous films.

As the electrolyte layer 4, a fused salt or a solid electrolyte may be used as it is. Examples of the solid electrolyte include an oxide-based one and a sulfide one. Examples of the oxide-based solid electrolyte include Li₇La₃Zr₂O₁₂, which is a composite metal oxide of Li, La and Zr, a composite metal oxide in which a part of the former composite metal oxide is substituted with at least one metal selected from the group consisting of Sr, Ba, Ag, Y, Bi, Pb, Sn, Sb, Hf, Ta and Nb, and a glass ceramic containing Li, Al, Si, Ti, Ge and P as main components.

In the metal oxygen battery 1, the positive electrode current collector 9 usable is, for example, a metal mesh comprising Ti, Ni, stainless steel or the like. The negative electrode current collector 10 usable is a metal plate or a metal mesh comprising Ti, Ni, Cu, Al, stainless steel or the like, or a carbon paper.

In the metal oxygen battery 1, since the positive electrode 2, the negative electrode 3, the electrolyte layer 4, the positive electrode current collector 9 and the negative electrode current collector 10 are hermetically housed in the case 5, moisture, carbon dioxide and the like in the air can be prevented from penetrating into the metal oxygen battery 1.

In the metal oxygen battery 1, during discharge, the cell reaction occurs in which while the metal is oxidized to form metal ions at the negative electrode 3, oxygen desorbed from the composite metal oxide is reduced to form oxygen ions in the positive electrode 2. The oxygen is reduced by a catalytic function of the composite metal oxide itself. At the positive electrode 2, oxygen ions also are released from the composite metal oxide. The oxygen ions combine with the metal ions to form a metal oxide, and the metal oxide is accommodated in the pores in the positive electrode 2.

At this time, in the metal oxygen battery 1, since the positive electrode 2, the negative electrode 3, the electrolyte layer 4, the positive electrode current collector 9 and the negative electrode current collector 10 are hermetically housed in the case 5, the oxygen present in the positive electrode 2 is only oxygen released from the oxygen-storing material. Therefore, the crystallization of the metal oxide formed in the positive electrode 2 is suppressed and the metal oxide results in becoming a metal oxide containing an amorphous.

During charge, at the positive electrode 2, the metal oxide is reduced by the catalytic function of the composite metal oxide itself, and oxygen is released; and the oxygen is accommodated in the pores in the positive electrode 2, and thereafter adsorbed on the composite metal oxide, or occluded as oxygen ions in the composite metal oxide. On the other hand, at the negative electrode 3, the metal ions are reduced to form a metal.

At this time, in the metal oxygen battery 1, that the metal oxide contains an amorphous allows easy reduction of the metal oxide, suppresses the generation of the overvoltage, and can provide an excellent charge/discharge capacity. In the metal oxygen battery 1, since the metal oxide can easily be reduced during charge, the generation of an irreversible capacity due to the metal oxide remaining without being reduced is suppressed and an excellent cycle performance can be provided.

Then, Examples and Comparative Examples of the present invention will be described.

### Example 1

In the present Example, first, yttrium nitrate pentahydrate, manganese nitrate hexahydrate and malic acid in a molar ratio of 1:1:6 were crushed and mixed to thereby obtain a mixture of composite metal oxide materials. Then, the obtained mixture of composite metal oxide materials was caused to react at a temperature of 250° C. for 30 min, and thereafter further caused to react at a temperature of 300° C. for 30 min, and at a temperature of 350° C. for 1 hour. Then, a mixture of the reaction products was crushed and mixed, and thereafter fired at a temperature of 1,000° C. for 1 hour to thereby obtain a composite metal oxide.

The obtained composite metal oxide was confirmed to be a composite metal oxide represented by the chemical formula YMnO₃, and have a hexagonal structure by the X-ray diffraction pattern.

Then, 10 parts by mass of the obtained YMnO₃, 80 parts by mass of Ketjen black (made by Lion Corp.) as a conductive auxiliary, and 10 parts by mass of a polytetrafluoroethylene (made by Daikin Industries, Ltd.) as a binder were mixed to thereby obtain a positive electrode material mixture. Then, the obtained positive electrode material mixture was pressure bonded at a pressure of 5 MPa to a positive electrode current collector 9 composed of a Ti mesh of 15 mm in diameter to thereby form a positive electrode 2 of 15 mm in diameter and 1 mm in thickness. The positive electrode 2 thus obtained was confirmed to have a porosity of 78% by volume by the mercury intrusion method.

Then, a negative electrode current collector 10 composed of a stainless steel of 15 mm in diameter was disposed inside a stainless steel-made case body 6 of a bottomed cylinder-form of 15 mm in inner diameter; and a negative electrode 3 composed of metallic lithium of 15 mm in diameter and 0.1 mm in thickness was superposed on the negative electrode current collector 10.

Then, a separator composed of a glass fiber (made by Nippon Sheet Glass Co., Ltd.) of 15 mm in diameter was superposed on the negative electrode 3. Then, the positive electrode 2 and the positive electrode current collector 9 obtained as described above were superposed on the separator so that the positive electrode 2 contacted with the separator. Then, a nonaqueous electrolyte solution was injected into the separator to thereby form an electrolyte layer 4.

As the nonaqueous electrolyte solution, a solution (made by Kishida Chemical Co., Ltd.) was used in which lithium hexafluorophosphate (LiPF₆) as a supporting salt was dissolved in a concentration of 1 mol/l in a mixed solution of 50 parts by mass of ethylene carbonate and 50 parts by mass of diethyl carbonate.

Then, a laminate body composed of the negative electrode current collector 10, the negative electrode 3, the electrolyte layer 4, the positive electrode 2 and the positive electrode current collector 9 housed in the case body 6 was covered with a lid body 7. At this time, a ring-form insulating resin 8 composed of a polytetrafluoroethylene (PTFE) of 32 mm in outer diameter, 30 mm in inner diameter and 5 mm in thickness was disposed between the case body 6 and the lid body 7; thus, a metal oxygen battery 1 shown in FIG. 1 was obtained.

Then, the metal oxygen battery 1 obtained in the present Example was mounted on an electrochemical measurement apparatus (made by Toho Technical Research Co., Ltd.); and a current of 0.3 mA/cm² was impressed between the negative electrode 3 and the positive electrode 2 to carry out the discharge until the cell voltage reached 2.0 V, and a relationship between the cell voltage and the capacity during discharge was measured.

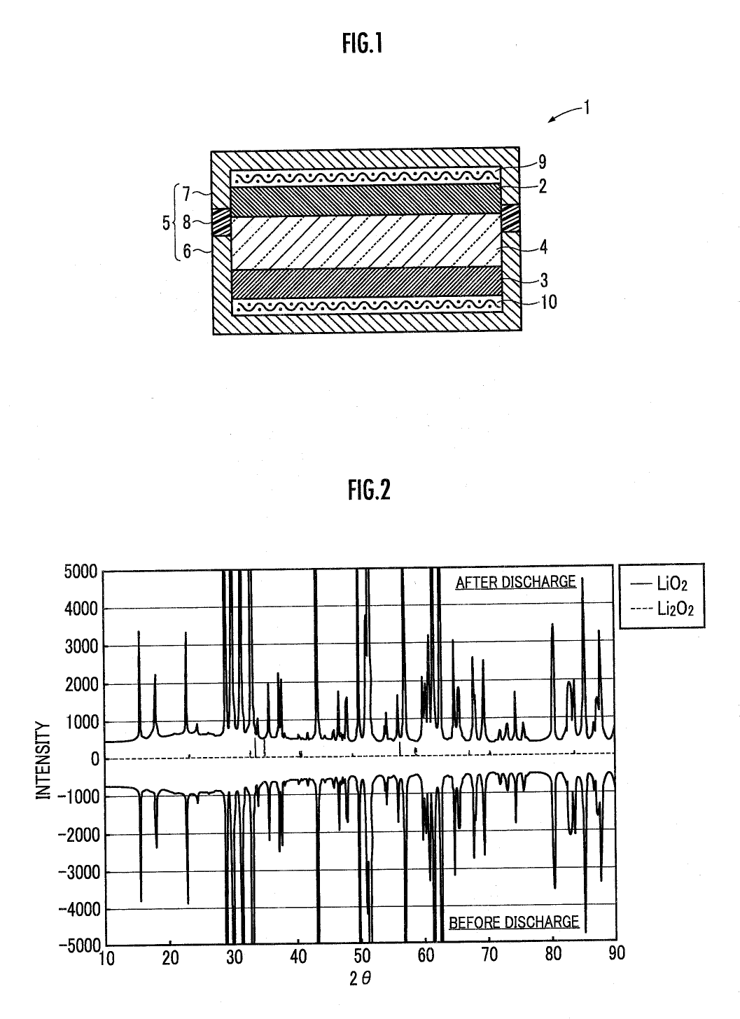

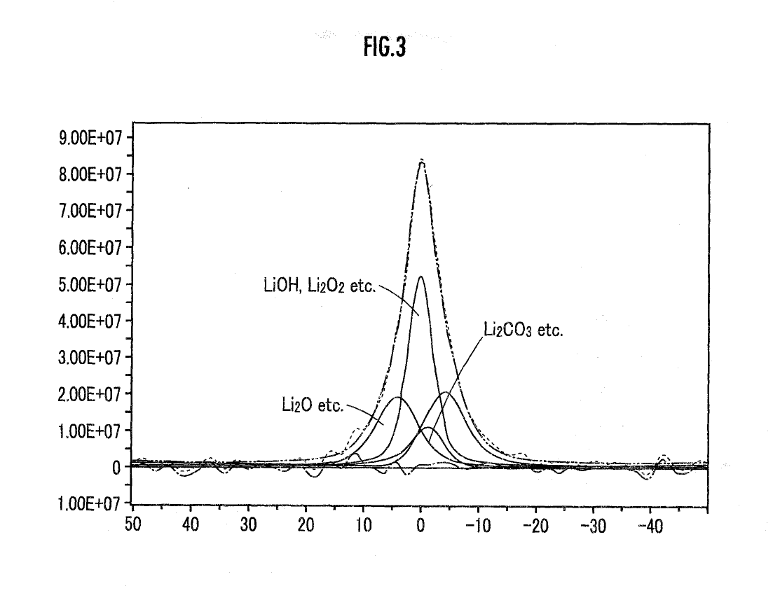

At this time, X-ray diffraction patterns for the positive electrode 2 were measured before and after the discharge, and Li-NMR after the discharge was measured. The X-ray diffraction patterns are shown in FIG. 2, and the measurement result of the Li-NMR is shown in FIG. 3.

From FIG. 2, it is clear that in the positive electrode 2 of the metal oxygen battery 1 obtained in the present Example, peaks of the crystals of lithium oxides (Li₂O, Li₂O₂) were not observed in either of before the discharge and after the discharge. On the other hand, from FIG. 3, it is clear that lithium oxides (Li₂O, Li₂O₂) were present in the positive electrode 2 after the discharge. Therefore, it is clear that the positive electrode 2 of the metal oxygen battery 1 obtained in the present Example contained amorphous lithium oxides.

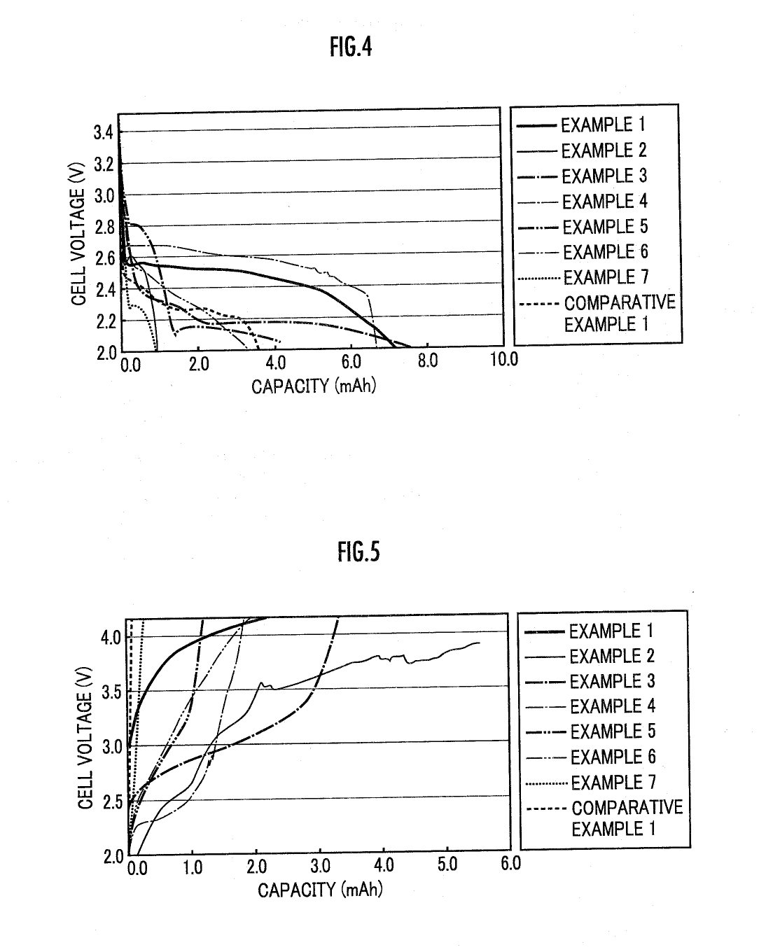

The relationship between the cell voltage and the capacity during discharge is shown in FIG. 4.

Then, the metal oxygen battery 1 obtained in the present Example was mounted on an electrochemical measurement apparatus (made by Toho Technical Research Co., Ltd.); and a current of 0.3 mA/cm² was impressed between the negative electrode 3 and the positive electrode 2 to carry out the charge until the cell voltage reached 4.0 V, and a relationship between the cell voltage and the capacity during charge was measured. The relationship between the cell voltage and the capacity during charge is shown in FIG. 5.

From FIG. 4, it is clear that according to the metal oxygen battery 1 of the present Example in which the positive electrode 2, the negative electrode 3 and the electrolyte layer 4 were hermetically housed, formation of amorphous lithium oxides during discharge can suppress the overvoltage, and can provide an excellent charge/discharge capacity.

### Example 2

In the present Example, first, copper sulfate, iron nitrate and malic acid in a molar ratio of 1:1:6 were crushed and mixed to thereby obtain a mixture of composite metal oxide materials. Then, the obtained mixture of composite metal oxide materials was caused to react at a temperature of 250° C. for 30 min, and thereafter further caused to react at a temperature of 300° C. for 30 min, and at a temperature of 350° C. for 1 hour. Then, a mixture of the reaction products was crushed and mixed, and thereafter fired at a temperature of 1,200° C. for 1 hour to thereby obtain a composite metal oxide.

The obtained composite metal oxide was confirmed to be a composite metal oxide represented by the chemical formula CuFeO₂, and have a delafossite structure by the X-ray diffraction pattern.

Then, a metal oxygen battery 1 shown in FIG. 1 was obtained wholly as in Example 1, except for using the CuFeO₂ obtained in the present Example.

Then, a relationship between the cell voltage and the capacity during discharge was measured wholly as in Example 1, except for using the metal oxygen battery 1 obtained in the present Example. The result is shown in FIG. 4.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 5.

### Example 3

In the present Example, first, zirconium oxynitrate was fired at a temperature of 800° C. for 1 hour to thereby obtain a metal oxide. The obtained metal oxide was confirmed to be a metal oxide represented by the chemical formula ZrO₂, and have a fluorite structure by the X-ray diffraction pattern.

Then, a metal oxygen battery 1 shown in FIG. 1 was obtained wholly as in Example 1, except for using the ZrO₂ obtained in the present Example.

Then, a relationship between the cell voltage and the capacity during discharge was measured wholly as in Example 1, except for using the metal oxygen battery 1 obtained in the present Example. The result is shown in FIG. 4.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 5.

### Example 4

In the present Example, first, cerium nitrate was fired at a temperature of 600° C. for 1 hour to thereby obtain a metal oxide. The obtained metal oxide was confirmed to be a metal oxide represented by the chemical formula CeO₂, and have a fluorite structure by the X-ray diffraction pattern.

Then, a metal oxygen battery 1 shown in FIG. 1 was obtained wholly as in Example 1, except for using the CeO₂ obtained in the present Example.

Then, a relationship between the cell voltage and the capacity during discharge was measured wholly as in Example 1, except for using the metal oxygen battery 1 obtained in the present Example. The result is shown in FIG. 4.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 5.

### Example 5

In the present Example, first, lanthanum nitrate, manganese nitrate and malic acid in a molar ratio of 1:1:6 were crushed and mixed to thereby obtain a mixture of composite metal oxide materials. Then, the obtained mixture of composite metal oxide materials was caused to react at a temperature of 250° C. for 30 min, and thereafter further caused to react at a temperature of 300° C. for 30 min, and at a temperature of 350° C. for 1 hour. Then, a mixture of the reaction products was crushed and mixed, and thereafter fired at a temperature of 1,000° C. for 1 hour to thereby obtain a composite metal oxide.

The obtained composite metal oxide was confirmed to be a composite metal oxide represented by the chemical formula LaMnO₃, and have a perovskite structure by the X-ray diffraction pattern.

Then, a metal oxygen battery 1 shown in FIG. 1 was obtained wholly as in Example 1, except for using the LaMnO₃ obtained in the present Example.

Then, a relationship between the cell voltage and the capacity during discharge was measured wholly as in Example 1, except for using the metal oxygen battery 1 obtained in the present Example. The result is shown in FIG. 4.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 5.

### Example 6

In the present Example, first, lanthanum nitrate, nickel nitrate and malic acid in a molar ratio of 1:1:6 were crushed and mixed to thereby obtain a mixture of composite metal oxide materials. Then, the obtained mixture of composite metal oxide materials was caused to react at a temperature of 250° C. for 30 min, and thereafter further caused to react at a temperature of 300° C. for 30 min, and at a temperature of 350° C. for 1 hour. Then, a mixture of the reaction products was crushed and mixed, and thereafter fired at a temperature of 1,000° C. for 1 hour to thereby obtain a composite metal oxide.

The obtained composite metal oxide was confirmed to be a composite metal oxide represented by the chemical formula LaNiO₃, and have a perovskite structure by the X-ray diffraction pattern.

Then, a metal oxygen battery 1 shown in FIG. 1 was obtained wholly as in Example 1, except for using the LaNiO₃ obtained in the present Example.

Then, a relationship between the cell voltage and the capacity during discharge was measured wholly as in Example 1, except for using the metal oxygen battery 1 obtained in the present Example. The result is shown in FIG. 4.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 5.

### Example 7

In the present Example, first, lanthanum nitrate, silicon oxide and malic acid in a molar ratio of 1:1:6 were crushed and mixed to thereby obtain a mixture of composite metal oxide materials. Then, the obtained mixture of composite metal oxide materials was caused to react at a temperature of 250° C. for 30 min, and thereafter further caused to react at a temperature of 300° C. for 30 min, and at a temperature of 350° C. for 1 hour. Then, a mixture of the reaction products was crushed and mixed, and thereafter fired at a temperature of 1,000° C. for 1 hour to thereby obtain a composite metal oxide.

The obtained composite metal oxide was confirmed to be a composite metal oxide represented by the chemical formula LaSiO₃, and have a perovskite structure by the X-ray diffraction pattern.

Then, a metal oxygen battery 1 shown in FIG. 1 was obtained wholly as in Example 1, except for using the LaSiO₃ obtained in the present Example.

Then, a relationship between the cell voltage and the capacity during discharge was measured wholly as in Example 1, except for using the metal oxygen battery 1 obtained in the present Example. The result is shown in FIG. 4.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 5.

### Example 8

In the present Example, first, gadolinium nitrate hexahydrate, yttrium nitrate hexahydrate and barium nitrate in a molar ratio of 1:1:0.1 were crushed and mixed, and the obtained mixture of composite metal oxide materials was dissolved in a 1-mol/l ammonium carbonate aqueous solution. The obtained aqueous solution was regulated at a pH of 10 by using ammonia water of a concentration of 10% by mass. Then, the aqueous solution was stirred at a temperature of 40° C. at a rotation frequency of 500 rpm overnight. Thereafter, the aqueous solution was suction filtrated and the obtained precipitate was washed with pure water, and thereafter dried, and fired in the air at a temperature of 900° C. for 2 hours to thereby obtain a composite metal oxide.

The obtained composite metal oxide was confirmed to be a composite metal oxide represented by the chemical formula (Gd_{0.7}Y_{0.26}Ba_{0.04})₂O₃, and have a cubic structure by the X-ray diffraction pattern.

Then, 40 parts by mass of the obtained (Gd_{0.7}Y_{0.26}Ba_{0.04})₂O₃, 40 parts by mass of Ketjen black (made by Lion Corp.) as a conductive auxiliary, and 10 parts by mass of a polytetrafluoroethylene (made by Daikin Industries, Ltd.) as a binder were mixed to thereby obtain a positive electrode material mixture. Then, the obtained positive electrode material mixture was pressure bonded at a pressure of 5 MPa to a positive electrode current collector 9 composed of an Al mesh of 15 mm in diameter to thereby form a positive electrode 2 of 15 mm in diameter and 1 mm in thickness.

Then, a metal oxygen battery 1 shown in FIG. 1 was obtained wholly as in Example 1, except for using the positive electrode 2 obtained in the present Example.

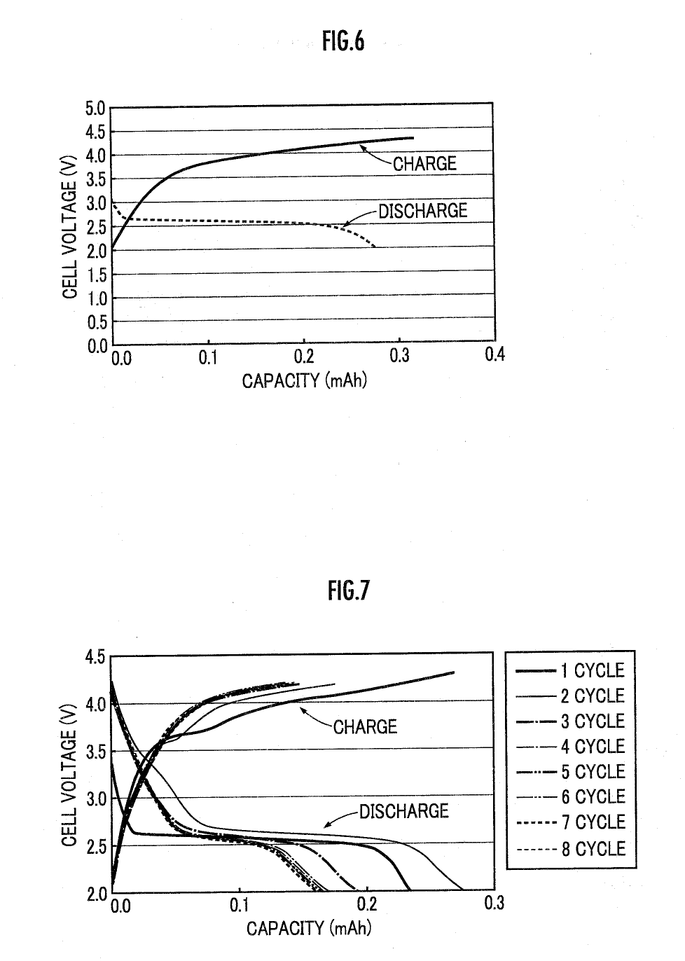

Then, a relationship between the cell voltage and the capacity during discharge was measured wholly as in Example 1, except for using the metal oxygen battery 1 obtained in the present Example, and impressing a current of 0.1 mA/cm² to carry out the discharge until the cell voltage reached 2.0 V. Further, a relationship between the cell voltage and the capacity during charge was measured wholly as in Example 1, except for using the metal oxygen battery 1 obtained in the present Example, and impressing a current of 0.1 mA/cm² to carry out the charge until the cell voltage reached 4.0 V. The result is shown in FIG. 6.

### Example 9

In the present Example, first, yttrium nitrate pentahydrate, silver nitrate, manganese nitrate hexahydrate and malic acid in a molar ratio of 0.9:0.1:1:6 were crushed and mixed to thereby obtain a mixture of composite metal oxide materials. Then, the obtained mixture of composite metal oxide materials was caused to react at a temperature of 250° C. for 30 min, and thereafter further caused to react at a temperature of 300° C. for 30 min, and at a temperature of 350° C. for 1 hour. Then, a mixture of the reaction products was crushed and mixed, and thereafter fired at a temperature of 1,000° C. for 1 hour to thereby obtain a composite metal oxide.

The obtained composite metal oxide was confirmed to be a composite metal oxide represented by the chemical formula Y_{0.9}Ag_{0.1}MnO₃, and have a rhombic structure by the X-ray diffraction pattern.

Then, a metal oxygen battery 1 shown in FIG. 1 was obtained wholly as in Example 8, except for using the Y_{0.9}Ag_{0.1}MnO₃ obtained in the present Example.

Then, the operation of the measurements of relationships between the cell voltage and the capacity in the charge and the discharge time wholly as in Example 8, except for using the metal oxygen battery 1 obtained in the present Example, was repeated by 8 cycles. The results are shown in FIG. 7.

### Comparative Example 1

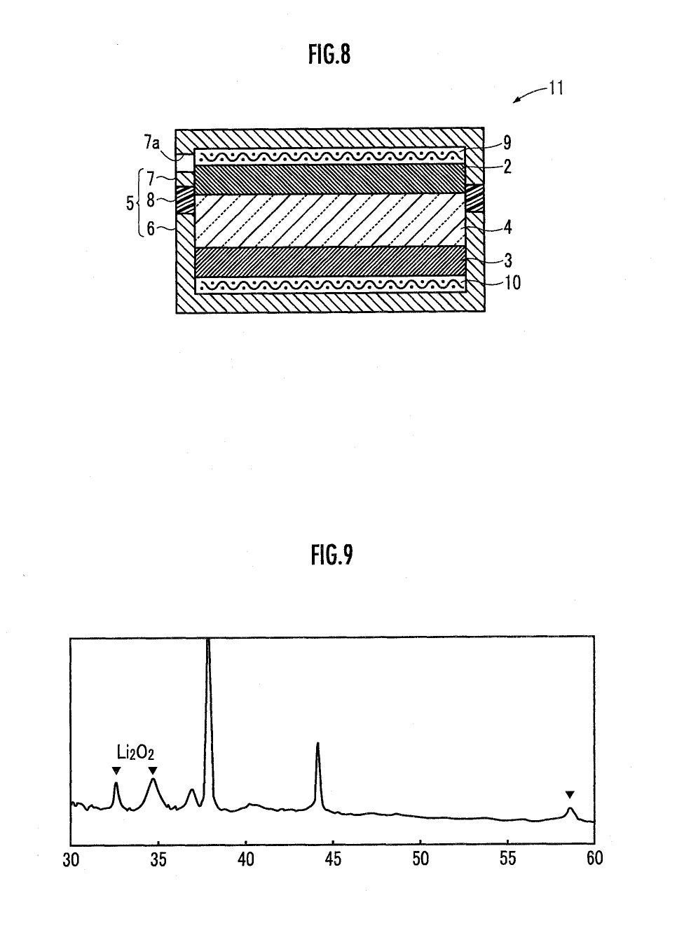

In the present Comparative Example, as shown in FIG. 8, a metal oxygen battery 11 was obtained wholly as in the above Example 1, except for using a lid body 7 having an air-introducing hole 7a of 3 mm in diameter in the side wall. In the metal oxygen battery 11, the positive electrode 2 was opened to the atmosphere through the air-introducing hole 7a.

Then, a relationship between the cell voltage and the capacity during discharge was measured wholly as in Example 1, except for using the metal oxygen battery 11 obtained in the present Comparative Example. The result is shown in FIG. 4.

At this time, for the positive electrode 2, the X-ray diffraction pattern after the discharge was measured. The result is shown in FIG. 9.

Then, a relationship between the cell voltage and the capacity during charge was measured wholly as in Example 1, except for using the metal oxygen battery 11 obtained in the present Comparative Example. The result is shown in FIG. 5.

From FIGS. 4 to 6, it is clear that the metal oxygen batteries 1 (Examples 1 to 8) in which the positive electrode 2, the negative electrode 3 and the electrolyte layer 4 were hermetically housed had a larger charge/discharge capacity than the metal oxygen battery 11 (Comparative Example 1) in which the positive electrode 2 was opened to the atmosphere.

This is conceivably because in the metal oxygen batteries 1 (Examples 1 to 8), the positive electrodes 2 contained amorphous lithium oxides as in Example 1, and the formation of the amorphous lithium oxides during discharge could suppress the overvoltage and could provide an excellent charge/discharge capacity.

On the other hand, in the metal oxygen battery 11 (Comparative Example 1), as shown in FIG. 9, peaks of the crystals of lithium oxides (Li₂O, Li₂O₂) were observed after the discharge, and it is clear that crystal particles of the lithium oxides were present. This is conceivably because in the metal oxygen battery 11, since the positive electrode 2 was opened to the atmosphere, the crystal particles of lithium oxides grew and were coarsened in the positive electrode 2. Consequently, it is conceivable that in the metal oxygen battery 11, since the three-phase interface was broken and the overvoltage became large, the charge/discharge capacity became small.

The positive electrode 2 of the metal oxygen battery 1 obtained in Example 9 conceivably contained amorphous lithium oxides as in Examples 1 to 8, and the formation of the amorphous lithium oxides during discharge could suppress the overvoltage and could provide an excellent charge/discharge capacity. Further during charge, since the amorphous lithium oxides could easily be reduced, the generation of an irreversible capacity due to the lithium oxides remaining without being reduced could be suppressed.

Therefore, it is clear from FIG. 7 that the metal oxygen battery 1 of Example 9 could provide an excellent cycle performance.

### Example 10

In the present Example, a metal oxygen battery 1 shown in FIG. 1 was obtained wholly as in Example 1, except for using metallic zinc for the negative electrode 3, using an aluminum mesh for the positive electrode current collector 9, and using a KOH solution of a concentration of 1 mol/l as an electrolyte solution.

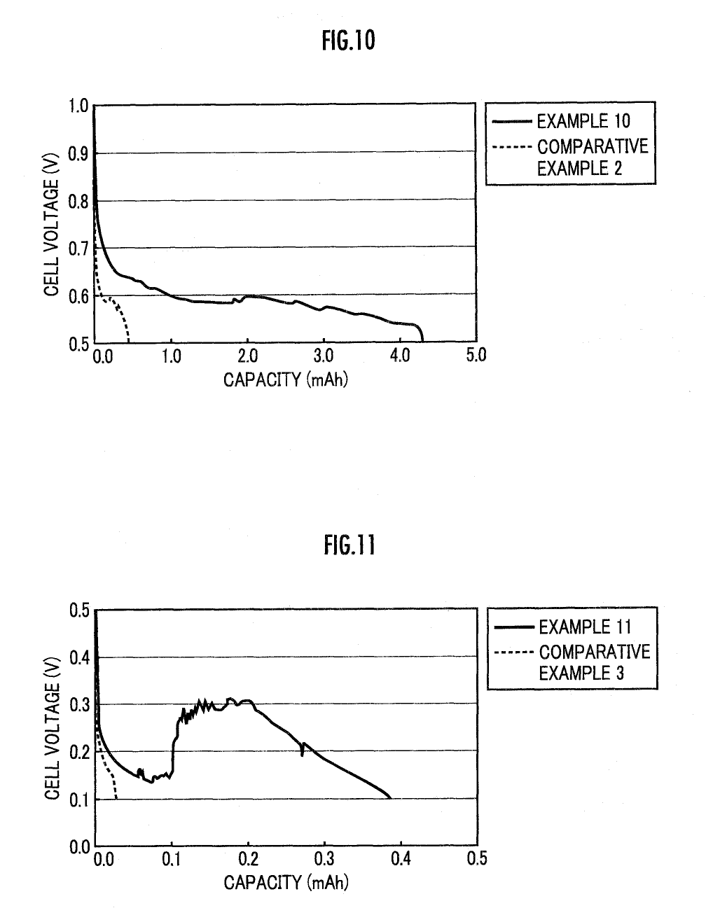

Then, a relationship between the cell voltage and the capacity during discharge was measured wholly as in Example 1, except for using the metal oxygen battery 1 obtained in the present Example. The result is shown in FIG. 10.

### Comparative Example 2

In the present Comparative Example, a metal oxygen battery 11 shown in FIG. 8 was obtained wholly as in Comparative Example 1, except for using metallic zinc for the negative electrode 3, using an aluminum mesh for the positive electrode current collector 9, and using a KOH solution of a concentration of 1 mol/l as an electrolyte solution.

Then, a relationship between the cell voltage and the capacity during discharge was measured wholly as in Example 1, except for using the metal oxygen battery 11 obtained in the present Comparative Example. The result is shown in FIG. 10.

From FIG. 10, it is clear also in the case of using metallic zinc for the negative electrode 3 that the metal oxygen battery 1 (Example 10) in which the positive electrode 2, the negative electrode 3 and the electrolyte layer 4 were hermetically housed had a larger discharge capacity than the metal oxygen battery 11 (Comparative Example 2) in which the positive electrode 2 was opened to the atmosphere.

This is conceivably because in the metal oxygen battery 1 of Example 10, the positive electrode 2 contained an amorphous (zinc oxide) as in Example 1, and the formation of the amorphous (zinc oxide) during discharge could suppress the overvoltage and could provide an excellent discharge capacity. On the other hand, in the metal oxygen battery 11 of Comparative Example 2, it is conceivable that since the positive electrode 2 was opened to the atmosphere, the crystal particles of the metal oxide (zinc oxide) grew and were coarsened in the positive electrode 2, and the three-phase interface was broken and the overvoltage became large, so the discharge capacity became small.

### Example 11

In the present Example, a metal oxygen battery 1 shown in FIG. 1 was obtained wholly as in Example 1, except for using metallic iron for the negative electrode 3, using an aluminum mesh for the positive electrode current collector 9, and using a KOH solution of a concentration of 1 mol/1 as an electrolyte solution.

Then, a relationship between the cell voltage and the capacity during discharge was measured wholly as in Example 1, except for using the metal oxygen battery 1 obtained in the present Example. The result is shown in FIG. 11.

### Comparative Example 3

In the present Comparative Example, a metal oxygen battery 11 shown in FIG. 8 was obtained wholly as in Comparative Example 1, except for using metallic iron for the negative electrode 3, using aluminum for the positive electrode current collector 9, and using a KOH solution of a concentration of 1 mol/1 as an electrolyte solution.

Then, a relationship between the cell voltage and the capacity during discharge was measured wholly as in Example 1, except for using the metal oxygen battery 11 obtained in the present Comparative Example. The result is shown in FIG. 11.

From FIG. 11, it is clear also in the case of using metallic iron for the negative electrode 3 that the metal oxygen battery 1 (Example 11) in which the positive electrode 2, the negative electrode 3 and the electrolyte layer 4 were hermetically housed had a larger discharge capacity than the metal oxygen battery 11 (Comparative Example 3) in which the positive electrode 2 was opened to the atmosphere.

This is conceivably because in the metal oxygen battery 1 of Example 11, the positive electrode 2 contained an amorphous (iron oxide) as in Example 1, and the formation of the amorphous (iron oxide) during discharge could suppress the overvoltage and could provide an excellent discharge capacity. On the other hand, in the metal oxygen battery 11 of Comparative Example 3, it is conceivable that since the positive electrode 2 was opened to the atmosphere, the crystal particles of the metal oxide (iron oxide) grew and were coarsened in the positive electrode 2, and the three-phase interface was broken and the overvoltage became large, so the discharge capacity became small.

### Example 12

In the present Example, a metal oxygen battery 1 shown in FIG. 1 was obtained wholly as in Example 1, except for using a Li—In alloy (molar ratio of 1:1) for the negative electrode 3, and using an aluminum mesh for the positive electrode current collector 9.

Then, a relationship between the cell voltage and the capacity during discharge was measured wholly as in Example 1, except for using the metal oxygen battery 1 obtained in the present Example. The result is shown in FIG. 12 together with the result of Comparative Example 1.

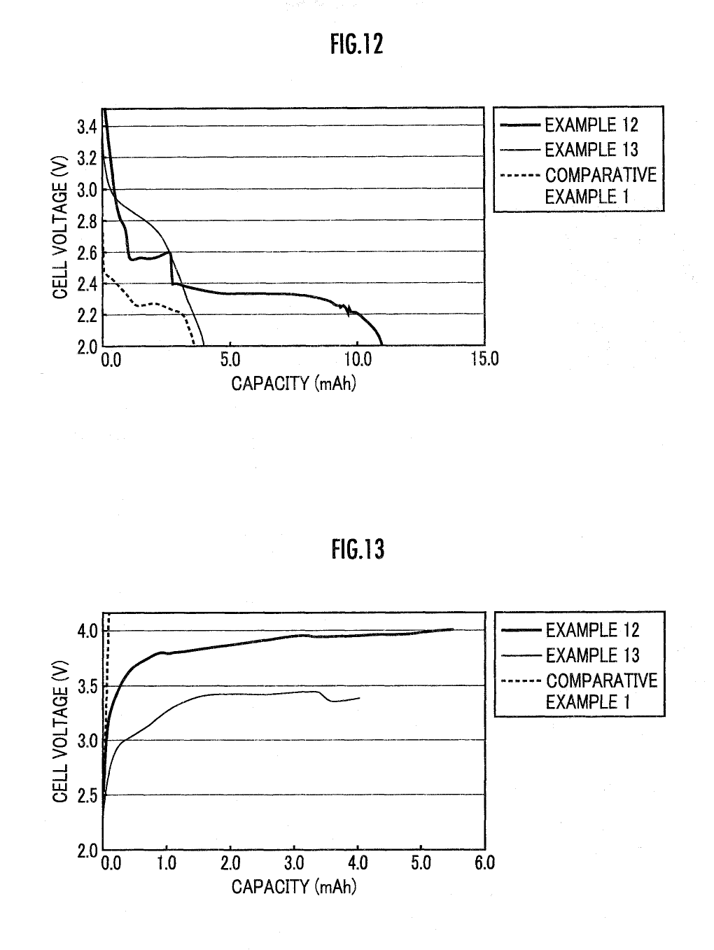

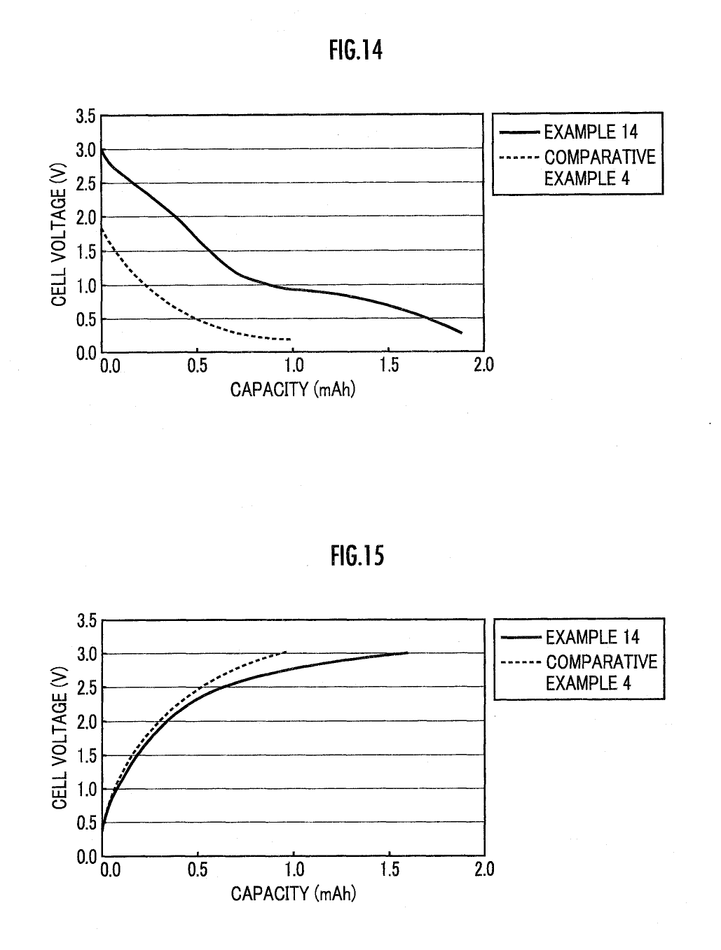

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 13 together with the result of Comparative Example 1.

### Example 13

In the present Example, a metal oxygen battery 1 shown in FIG. 1 was obtained wholly as in Example 1, except for using a material composed of 90 parts by mass of Si as an active substance, 5 parts by mass of Ketjen black (made by Lion Corp.) as a conductive auxiliary and 5 parts by mass of a polyimide as a binder, and having Li ions intercalated therein in advance, for the negative electrode 3, and using an aluminum mesh for the positive electrode current collector 9.

Then, a relationship between the cell voltage and the capacity during discharge was measured wholly as in Example 1, except for using the metal oxygen battery 1 obtained in the present Example. The result is shown in FIG. 12.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 13.

From FIGS. 12 and 13, it is clear also in the case of using the Li—In alloy or the Si having Li ions intercalated therein in advance for the negative electrode 3 that the metal oxygen batteries 1 (Examples 12 and 13) in which the positive electrode 2, the negative electrode 3 and the electrolyte layer 4 were hermetically housed had a larger charge/discharge capacity than the metal oxygen battery 11 (Comparative Example 1) in which the positive electrode 2 was opened to the atmosphere.

This is conceivably because in the metal oxygen batteries 1 of Examples 12 and 13, the positive electrode 2 contained amorphous lithium oxides as in Example 1, and the formation of the amorphous lithium oxides during discharge could suppress the overvoltage and could provide an excellent charge/discharge capacity. On the other hand, in the metal oxygen battery 11 of Comparative Example 1, it is conceivable that since the positive electrode 2 was opened to the atmosphere, the crystal particles of the lithium oxides grew and were coarsened in the positive electrode 2, and the three-phase interface was broken and the overvoltage became large, so the charge/discharge capacity became small.

### Example 14

In the present Example, a metal oxygen battery 1 shown in FIG. 1 was obtained wholly as in Example 1, except for using a material composed of 90 parts by mass of Li₄Ti₅O₁₂ as an active substance, 5 parts by mass of Ketjen black (made by Lion Corp.) as a conductive auxiliary and 5 parts by mass of a polytetrafluoroethylene (made by Daikin Industries, Ltd.) as a binder, for the negative electrode 3, and using an aluminum mesh for the positive electrode current collector 9.

Then, a relationship between the cell voltage and the capacity during discharge was measured wholly as in Example 1, except for using the metal oxygen battery 1 obtained in the present Example. The result is shown in FIG. 14.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 15.

### Comparative Example 4

In the present Comparative Example, a metal oxygen battery 11 shown in FIG. 8 was obtained wholly as in Comparative Example 1, except for using a material composed of 90% by mass of Li₄Ti₅O₁₂ as an active substance, 5 parts by mass of Ketjen black (made by Lion Corp.) as a conductive auxiliary and 5 parts by mass of a polytetrafluoroethylene (made by Daikin Industries, Ltd.) as a binder, for the negative electrode 3, and using an aluminum mesh for the positive electrode current collector 9.

Then, a relationship between the cell voltage and the capacity during discharge was measured wholly as in Example 1, except for using the metal oxygen battery 11 obtained in the present Comparative Example. The result is shown in FIG. 14.

Then, a relationship between the cell voltage and the capacity during charge was measured wholly as in Example 1, except for using the metal oxygen battery 11 obtained in the present Comparative Example, and carrying out the charge until the cell voltage reached 4.1 V. The result is shown in FIG. 15.

From FIGS. 14 and 15, it is clear also in the case of using Li₄Ti₅O₁₂ for the negative electrode 3 that the metal oxygen battery 1 (Example 14) in which the positive electrode 2, the negative electrode 3 and the electrolyte layer 4 were hermetically housed had a larger charge/discharge capacity than the metal oxygen battery 11 (Comparative Example 4) in which the positive electrode 2 was opened to the atmosphere.

This is conceivably because in the metal oxygen battery 1 of Example 14, the positive electrode 2 contained amorphous lithium oxides as in Example 1, and the formation of the amorphous lithium oxides during discharge could suppress the overvoltage and could provide an excellent charge/discharge capacity. On the other hand, in the metal oxygen battery 11 of Comparative Example 4, it is conceivable that since the positive electrode 2 was opened to the atmosphere, the crystal particles of the lithium oxides grew and were coarsened in the positive electrode 2, and the three-phase interface was broken and the overvoltage became large, so the charge/discharge capacity became small.

### Example 15

In the present Example, a metal oxygen battery 1 shown in FIG. 1 was obtained wholly as in Example 1, except for using metallic sodium for the negative electrode 3.

Then, a relationship between the cell voltage and the capacity during discharge was measured wholly as in Example 1, except for using the metal oxygen battery 1 obtained in the present Example, and impressing a current of 0.02 mA/cm² between the negative electrode 3 and the positive electrode 2 to carry out the discharge until the discharge capacity reached 1.0 mAh. Then, a relationship between the cell voltage and the capacity during charge was measured wholly as in Example 1, except for using the metal oxygen battery 1 obtained in the present Example, and impressing a current of 0.02 mA/cm² between the negative electrode 3 and the positive electrode 2 to carry out the charge until the cell voltage reached 4.2 V.

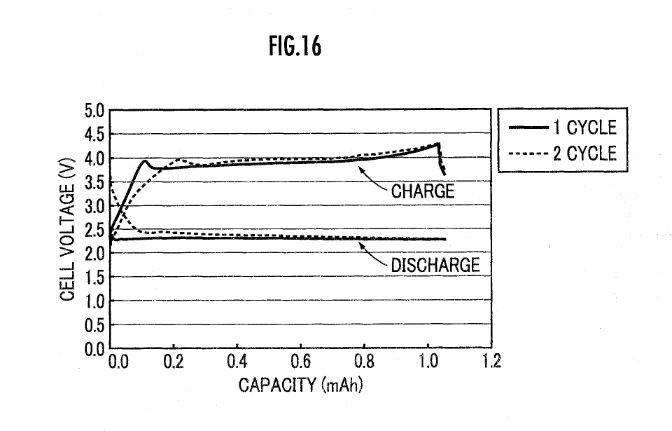

Then, the operation of the measurements of relationships between the cell voltage and the capacity in the charge and the discharge time was repeated by 2 cycles. The results are shown in FIG. 16.

The positive electrode 2 of the metal oxygen battery 1 obtained in the present Example conceivably contained an amorphous (sodium oxide) as in Example 1, and the formation of the amorphous (sodium oxide) during discharge could suppress the overvoltage and could provide an excellent charge/discharge capacity. Further during charge, since the amorphous (sodium oxide) could easily be reduced, the generation of an irreversible capacity due to the metal oxide (sodium oxide) remaining without being reduced could be suppressed.

Therefore, it is clear from FIG. 16 that the metal oxygen battery 1 of the present Example could provide an excellent cycle performance.

### Example 16

In the present Example, a metal oxygen battery 1 shown in FIG. 1 was obtained wholly as in Example 1, except for using an aluminum mesh for the positive electrode current collector 9, and pressure bonding the positive electrode material mixture at a pressure of 0.01 MPa to the positive electrode current collector 9 to thereby form the positive electrode 2. The positive electrode 2 thus obtained was confirmed to have a porosity of 96% by volume by the mercury intrusion method.

Then, a relationship between the cell voltage and the capacity during discharge was measured wholly as in Example 1, except for using the metal oxygen battery 1 obtained in the present Example. The result is shown in FIG. 17.

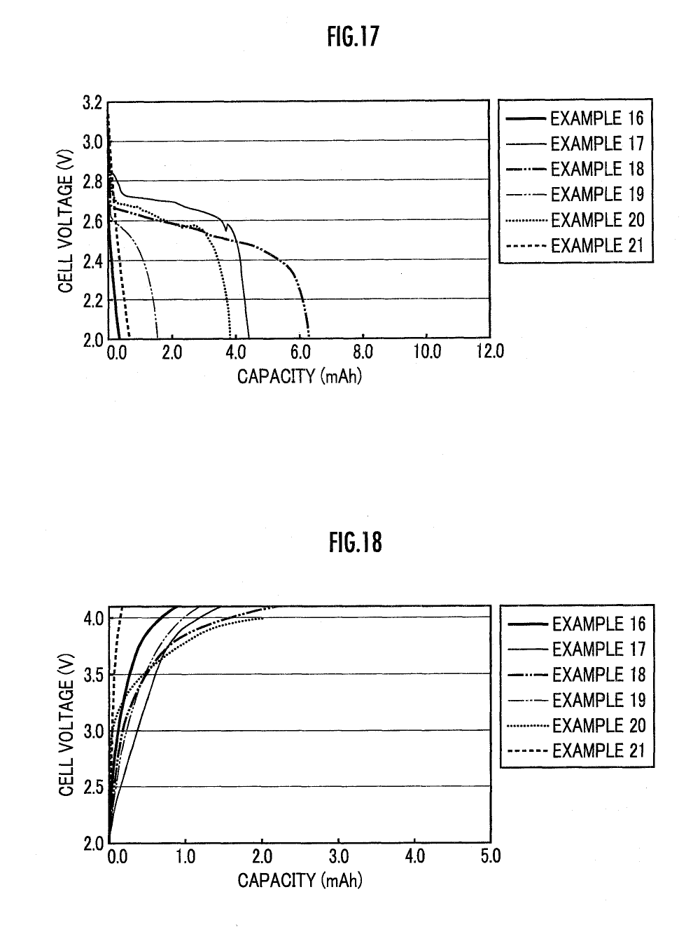

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 18.

### Example 17

In the present Example, a metal oxygen battery 1 shown in FIG. 1 was obtained wholly as in Example 1, except for using an aluminum mesh for the positive electrode current collector 9, and pressure bonding the positive electrode material mixture at a pressure of 0.05 MPa to the positive electrode current collector 9 to thereby form the positive electrode 2. The positive electrode 2 thus obtained was confirmed to have a porosity of 89% by volume by the mercury intrusion method.

Then, a relationship between the cell voltage and the capacity during discharge was measured wholly as in Example 1, except for using the metal oxygen battery 1 obtained in the present Example. The result is shown in FIG. 17.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 18.

### Example 18

In the present Example, a metal oxygen battery 1 shown in FIG. 1 was obtained wholly as in Example 1, except for using an aluminum mesh for the positive electrode current collector 9, and pressure bonding the positive electrode material mixture at a pressure of 10 MPa to the positive electrode current collector 9 to thereby form the positive electrode 2. The positive electrode 2 thus obtained was confirmed to have a porosity of 35.3% by volume by the mercury intrusion method.

Then, a relationship between the cell voltage and the capacity during discharge was measured wholly as in Example 1, except for using the metal oxygen battery 1 obtained in the present Example. The result is shown in FIG. 17.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 18.

### Example 19

In the present Example, a metal oxygen battery 1 shown in FIG. 1 was obtained wholly as in Example 1, except for using an aluminum mesh for the positive electrode current collector 9, and pressure bonding the positive electrode material mixture at a pressure of 20 MPa to the positive electrode current collector 9 to thereby form the positive electrode 2. The positive electrode 2 thus obtained was confirmed to have a porosity of 22.6% by volume by the mercury intrusion method.

Then, a relationship between the cell voltage and the capacity during discharge was measured wholly as in Example 1, except for using the metal oxygen battery 1 obtained in the present Example. The result is shown in FIG. 17.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 18.

### Example 20

In the present Example, a metal oxygen battery 1 shown in FIG. 1 was obtained wholly as in Example 1, except for using an aluminum mesh for the positive electrode current collector 9, and pressure bonding the positive electrode material mixture at a pressure of 50 MPa to the positive electrode current collector 9 to thereby form the positive electrode 2. The positive electrode 2 thus obtained was confirmed to have a porosity of 11.2% by volume by the mercury intrusion method.

Then, a relationship between the cell voltage and the capacity during discharge was measured wholly as in Example 1, except for using the metal oxygen battery 1 obtained in the present Example. The result is shown in FIG. 17.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 18.

### Example 21

In the present Example, a metal oxygen battery 1 shown in FIG. 1 was obtained wholly as in Example 1, except for using an aluminum mesh for the positive electrode current collector 9, and pressure bonding the positive electrode material mixture at a pressure of 100 MPa to the positive electrode current collector 9 to thereby form the positive electrode 2. The positive electrode 2 thus obtained was confirmed to have a porosity of 8.9% by volume by the mercury intrusion method.

Then, a relationship between the cell voltage and the capacity during discharge was measured wholly as in Example 1, except for using the metal oxygen battery 1 obtained in the present Example. The result is shown in FIG. 17.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 18.

It is clear from FIGS. 17 and 18 that the metal oxygen batteries 1 (Examples 17 to 20) in which the porosity of the positive electrode 2 was in the range of 10 to 90% by volume exhibited a better cell performance than the metal oxygen battery 1 (Example 21) in which the porosity was lower than 10% by volume or the metal oxygen battery 1 (Example 16) in which the porosity exceeded 90% by volume.

### Example 22

In the present Example, a metal oxygen battery 1 shown in FIG. 1 was obtained wholly as in Example 1, except for using an aluminum mesh for the positive electrode current collector 9, and using no Ketjen black at all as a conductive auxiliary and mixing 99 parts by mass of YMnO₃ and 1 part by mass of the polytetrafluoroethylene as a binder to thereby obtain a positive electrode material mixture.

Then, a relationship between the cell voltage and the capacity during discharge was measured wholly as in Example 1, except for using the metal oxygen battery 1 obtained in the present Example. The result is shown in FIG. 19.

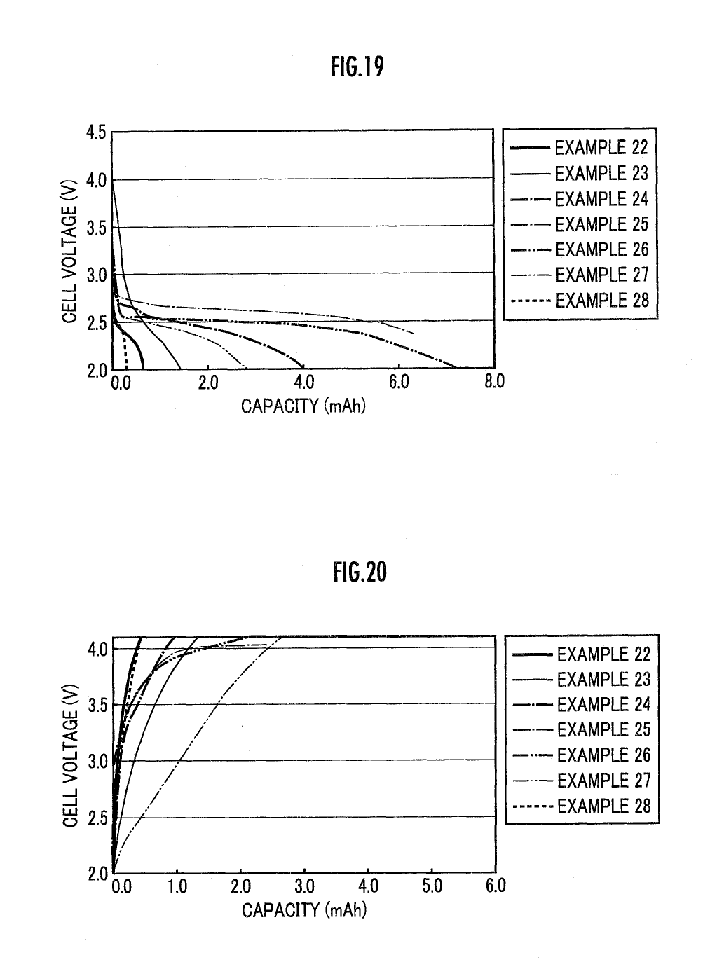

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 20.

### Example 23

In the present Example, a metal oxygen battery 1 shown in FIG. 1 was obtained wholly as in Example 1, except for using an aluminum mesh for the positive electrode current collector 9, and mixing 95 parts by mass of YMnO₃, 3 parts by mass of Ketjen black as a conductive auxiliary and 2 parts by mass of the polytetrafluoroethylene as a binder to thereby obtain a positive electrode material mixture.

Then, a relationship between the cell voltage and the capacity during discharge was measured wholly as in Example 1, except for using the metal oxygen battery 1 obtained in the present Example. The result is shown in FIG. 19.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 20.

### Example 24

In the present Example, a metal oxygen battery 1 shown in FIG. 1 was obtained wholly as in Example 1, except for using an aluminum mesh for the positive electrode current collector 9, and mixing 90 parts by mass of YMnO₃, 5 parts by mass of Ketjen black as a conductive auxiliary and 5 parts by mass of the polytetrafluoroethylene as a binder to thereby obtain a positive electrode material mixture.

Then, a relationship between the cell voltage and the capacity during discharge was measured wholly as in Example 1, except for using the metal oxygen battery 1 obtained in the present Example. The result is shown in FIG. 19.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 20.

### Example 25

In the present Example, a metal oxygen battery 1 shown in FIG. 1 was obtained wholly as in Example 1, except for using an aluminum mesh for the positive electrode current collector 9, and mixing 80 parts by mass of YMnO₃, 10 parts by mass of Ketjen black as a conductive auxiliary and 10 parts by mass of the polytetrafluoroethylene as a binder to thereby obtain a positive electrode material mixture.

Then, a relationship between the cell voltage and the capacity during discharge was measured wholly as in Example 1, except for using the metal oxygen battery 1 obtained in the present Example. The result is shown in FIG. 19.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 20.

### Example 26

In the present Example, a metal oxygen battery 1 shown in FIG. 1 was obtained wholly as in Example 1, except for using an aluminum mesh for the positive electrode current collector 9, and mixing 40 parts by mass of YMnO₃, 50 parts by mass of Ketjen black as a conductive auxiliary and 10 parts by mass of the polytetrafluoroethylene as a binder to thereby obtain a positive electrode material mixture.

Then, a relationship between the cell voltage and the capacity during discharge was measured wholly as in Example 1, except for using the metal oxygen battery 1 obtained in the present Example. The result is shown in FIG. 19.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 20.

### Example 27

In the present Example, a metal oxygen battery 1 shown in FIG. 1 was obtained wholly as in Example 1, except for using an aluminum mesh for the positive electrode current collector 9, and mixing 5 parts by mass of YMnO₃, 85 parts by mass of Ketjen black as a conductive auxiliary and 10 parts by mass of the polytetrafluoroethylene as a binder to thereby obtain a positive electrode material mixture.

Then, a relationship between the cell voltage and the capacity during discharge was measured wholly as in Example 1, except for using the metal oxygen battery 1 obtained in the present Example. The result is shown in FIG. 19.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 20.

### Example 28

In the present Example, a metal oxygen battery 1 shown in FIG. 1 was obtained wholly as in Example 1, except for using an aluminum mesh for the positive electrode current collector 9, and mixing 1 part by mass of YMnO₃, 89 parts by mass of Ketjen black as a conductive auxiliary and 10 parts by mass of the polytetrafluoroethylene as a binder to thereby obtain a positive electrode material mixture.

Then, a relationship between the cell voltage and the capacity during discharge was measured wholly as in Example 1, except for using the metal oxygen battery 1 obtained in the present Example. The result is shown in FIG. 19.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 20.

It is clear from FIGS. 19 and 20 that the metal oxygen batteries 1 (Examples 23 to 27) containing YMnO₃ in the range of 5 to 95 parts by mass based on the whole of the positive electrode material mixture exhibited a better cell performance than the metal oxygen battery 1 (Example 22) containing YMnO₃ exceeding 95 parts by mass, or the metal oxygen battery 1 (Example 28) containing YMnO₃ less than 5 parts by mass.

### Example 29

In the present Example, a metal oxygen battery 1 shown in FIG. 1 was obtained wholly as in Example 1, except for using propylene carbonate as a nonaqueous solvent for the electrolyte solution.

Then, a relationship between the cell voltage and the capacity during discharge was measured wholly as in Example 1, except for using the metal oxygen battery 1 obtained in the present Example, and carrying out the discharge until the cell voltage reached 2.0 V or the discharge capacity reached 6 mAh. The result is shown in FIG. 21.

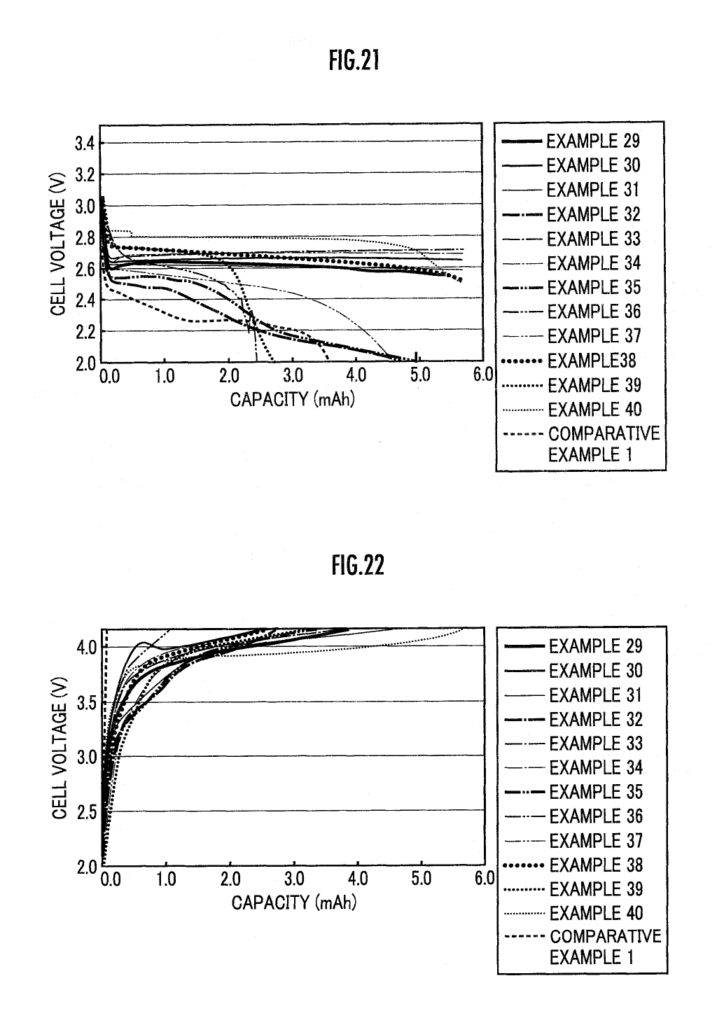

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 22.

### Example 30

In the present Example, a metal oxygen battery 1 shown in FIG. 1 was obtained wholly as in Example 1, except for using a mixed solution of 70 parts by mass of propylene carbonate and 30 parts by mass of dimethyl carbonate as a nonaqueous solvent for the electrolyte solution.

Then, a relationship between the cell voltage and the capacity during discharge was measured wholly as in Example 1, except for using the metal oxygen battery 1 obtained in the present Example, and carrying out the discharge until the cell voltage reached 2.0 V or the discharge capacity reached 6 mAh. The result is shown in FIG. 21.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 22.

### Example 31

In the present Example, a metal oxygen battery 1 shown in FIG. 1 was obtained wholly as in Example 1, except for using a mixed solution of 70 parts by mass of propylene carbonate and 30 parts by mass of diethyl carbonate as a nonaqueous solvent for the electrolyte solution.

Then, a relationship between the cell voltage and the capacity during discharge was measured wholly as in Example 1, except for using the metal oxygen battery 1 obtained in the present Example, and carrying out the discharge until the cell voltage reached 2.0 V or the discharge capacity reached 6 mAh. The result is shown in FIG. 21.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 22.

### Example 32

In the present Example, a metal oxygen battery 1 shown in FIG. 1 was obtained wholly as in Example 1, except for using a mixed solution of 50 parts by mass of propylene carbonate and 50 parts by mass of dimethyl carbonate as a nonaqueous solvent for the electrolyte solution.

Then, a relationship between the cell voltage and the capacity during discharge was measured wholly as in Example 1, except for using the metal oxygen battery 1 obtained in the present Example, and carrying out the discharge until the cell voltage reached 2.0 V or the discharge capacity reached 6 mAh. The result is shown in FIG. 21.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 22.

### Example 33

In the present Example, a metal oxygen battery 1 shown in FIG. 1 was obtained wholly as in Example 1, except for using a mixed solution of 50 parts by mass of propylene carbonate and 50 parts by mass of diethyl carbonate as a nonaqueous solvent for the electrolyte solution.

Then, a relationship between the cell voltage and the capacity during discharge was measured wholly as in Example 1, except for using the metal oxygen battery 1 obtained in the present Example, and carrying out the discharge until the cell voltage reached 2.0 V or the discharge capacity reached 6 mAh. The result is shown in FIG. 21.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 22.

### Example 34

In the present Example, a metal oxygen battery 1 shown in FIG. 1 was obtained wholly as in Example 1, except for using a mixed solution of 30 parts by mass of propylene carbonate and 70 parts by mass of dimethyl carbonate as a nonaqueous solvent for the electrolyte solution.

Then, a relationship between the cell voltage and the capacity during discharge was measured wholly as in Example 1, except for using the metal oxygen battery 1 obtained in the present Example, and carrying out the discharge until the cell voltage reached 2.0 V or the discharge capacity reached 6 mAh. The result is shown in FIG. 21.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 22.

### Example 35

In the present Example, a metal oxygen battery 1 shown in FIG. 1 was obtained wholly as in Example 1, except for using a mixed solution of 30 parts by mass of propylene carbonate and 70 parts by mass of diethyl carbonate as a nonaqueous solvent for the electrolyte solution.

Then, a relationship between the cell voltage and the capacity during discharge was measured wholly as in Example 1, except for using the metal oxygen battery 1 obtained in the present Example, and carrying out the discharge until the cell voltage reached 2.0 V or the discharge capacity reached 6 mAh. The result is shown in FIG. 21.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 22.

### Example 36

In the present Example, a metal oxygen battery 1 shown in FIG. 1 was obtained wholly as in Example 1, except for using a mixed solution of 70 parts by mass of ethylene carbonate and 30 parts by mass of dimethyl carbonate as a nonaqueous solvent for the electrolyte solution.

Then, a relationship between the cell voltage and the capacity during discharge was measured wholly as in Example 1, except for using the metal oxygen battery 1 obtained in the present Example, and carrying out the discharge until the cell voltage reached 2.0 V or the discharge capacity reached 6 mAh. The result is shown in FIG. 21.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 22.

### Example 37

In the present Example, a metal oxygen battery 1 shown in FIG. 1 was obtained wholly as in Example 1, except for using a mixed solution of 70 parts by mass of ethylene carbonate and 30 parts by mass of diethyl carbonate as a nonaqueous solvent for the electrolyte solution.

Then, a relationship between the cell voltage and the capacity during discharge was measured wholly as in Example 1, except for using the metal oxygen battery 1 obtained in the present Example, and carrying out the discharge until the cell voltage reached 2.0 V or the discharge capacity reached 6 mAh. The result is shown in FIG. 21.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 22.

### Example 38

In the present Example, a metal oxygen battery 1 shown in FIG. 1 was obtained wholly as in Example 1, except for using a mixed solution of 50 parts by mass of ethylene carbonate and 50 parts by mass of dimethyl carbonate as a nonaqueous solvent for the electrolyte solution.

Then, a relationship between the cell voltage and the capacity during discharge was measured wholly as in Example 1, except for using the metal oxygen battery 1 obtained in the present Example, and carrying out the discharge until the cell voltage reached 2.0 V or the discharge capacity reached 6 mAh. The result is shown in FIG. 21.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 22.

### Example 39

In the present Example, a metal oxygen battery 1 shown in FIG. 1 was obtained wholly as in Example 1, except for using a mixed solution of 30 parts by mass of ethylene carbonate and 70 parts by mass of dimethyl carbonate as a nonaqueous solvent for the electrolyte solution.

Then, a relationship between the cell voltage and the capacity during discharge was measured wholly as in Example 1, except for using the metal oxygen battery 1 obtained in the present Example, and carrying out the discharge until the cell voltage reached 2.0 V or the discharge capacity reached 6 mAh. The result is shown in FIG. 21.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 22.

### Example 40

In the present Example, a metal oxygen battery 1 shown in FIG. 1 was obtained wholly as in Example 1, except for using a mixed solution of 30 parts by mass of ethylene carbonate and 70 parts by mass of diethyl carbonate as a nonaqueous solvent for the electrolyte solution.

Then, a relationship between the cell voltage and the capacity during discharge was measured wholly as in Example 1, except for using the metal oxygen battery 1 obtained in the present Example, and carrying out the discharge until the cell voltage reached 2.0 V or the discharge capacity reached 6 mAh. The result is shown in FIG. 21.

Then, a relationship between the cell voltage and the capacity during charge was measured wholly as in Example 1, except for using the metal oxygen battery 1 obtained in the present Example, and carrying out the charge until the cell voltage reached 4.1 V. The result is shown in FIG. 22.

It is clear from FIGS. 21 and 22 that the metal oxygen batteries 1 (Examples 29 to 40), which used, as their nonaqueous solvents for the electrolyte solutions, propylene carbonate singly, a mixed solution of 30 to 70 parts by mass of propylene carbonate and 30 to 70 parts by mass of dimethyl carbonate or diethyl carbonate, or a mixed solution of 30 to 70 parts by mass of ethylene carbonate and 30 to 70 parts by mass of dimethyl carbonate or diethyl carbonate, could provide an excellent cell performance.

What is claimed is:

1. A metal oxygen battery, comprising:
a positive electrode comprising an oxygen-storing material to which oxygen is applied as an active substance;
a negative electrode to which a metal is applied as an active substance;
an electrolyte layer disposed between the positive electrode and the negative electrode; and
a case hermetically housing the positive electrode, the negative electrode and the electrolyte layer,
wherein the oxygen-storing material comprises functions of, during discharge, ionizing stored oxygen and releasing ionized oxygen, and causing the ionized oxygen to react with metal ions permeating from the negative electrode through the electrolyte layer into the positive electrode to thereby form a metal oxide, and of, during charge, storing oxygen formed by reduction of the metal oxide; and
during discharge, the oxygen-storing material ionizes stored oxygen and releases ionized oxygen, and causes the ionized oxygen to react with metal ions permeating from the negative electrode through the electrolyte layer into the positive electrode to thereby form a metal oxide, the metal oxide comprises an amorphous oxide.

2. The metal oxygen battery according to claim 1, wherein the oxygen-storing material has a catalytic function for a cell reaction.

3. The metal oxygen battery according to claim 1, wherein the oxygen-storing material comprises a metal oxide or a composite metal oxide.

4. The metal oxygen battery according to claim 3, wherein the positive electrode comprises the metal oxide or the composite metal oxide in the range of 5 to 95% by mass of the whole of the positive electrode, as the oxygen-storing material.

5. The metal oxygen battery according to claim 1, wherein the oxygen-storing material comprises a metal oxide or a composite metal oxide having at least one structure selected from the group consisting of a hexagonal structure, a C-rare earth structure, an apatite structure, a delafossite structure, a fluorite structure, a perovskite structure, a cubic structure and a rhombic structure.

6. The metal oxygen battery according to claim 1, wherein the oxygen-storing material comprises a metal oxide or a composite metal oxide having at least one structure selected from the group consisting of a hexagonal structure, a delafossite structure, a fluorite structure, a perovskite structure, a cubic structure and a rhombic structure.

7. The metal oxygen battery according to claim 6, wherein the composite metal oxide having a hexagonal structure comprises a composite metal oxide represented by the chemical formula YMnO₃.

8. The metal oxygen battery according to claim 6, wherein the composite metal oxide having a delafossite structure comprises a composite metal oxide represented by the chemical formula CuFeO₂.

9. The metal oxygen battery according to claim 6, wherein the metal oxide having a fluorite structure comprises any one metal oxide of a metal oxide represented by the chemical formula ZrO₂ and a metal oxide represented by the chemical formula CeO₂.

10. The metal oxygen battery according to claim 6, wherein the composite metal oxide having a perovskite structure comprises any one composite metal oxide of a composite metal oxide represented by the chemical formula LaMnO₃, a composite metal oxide represented by the chemical formula LaNiO₃ and a composite metal oxide represented by the chemical formula LaSiO₃.

11. The metal oxygen battery according to claim 6, wherein the composite metal oxide having a cubic structure comprises a composite metal oxide represented by the chemical formula (Gd_{0.7}Y_{0.26}Ba_{0.04})₂O₃.

12. The metal oxygen battery according to claim 6, wherein the composite metal oxide having a rhombic structure comprises a composite metal oxide represented by the chemical formula Y_{0.9}Ag_{0.1}MnO₃.

13. The metal oxygen battery according to claim 1, wherein the positive electrode comprises a conductive auxiliary having an electron conductivity.

14. The metal oxygen battery according to claim 1, wherein the positive electrode comprises a porous body having a porosity of 10 to 90% by volume.

15. The metal oxygen battery according to claim 1, wherein the negative electrode comprises one metal selected from the group consisting of Li, Zn, Al, Mg, Fe, Ca, Na and K, an alloy thereof, an organometallic compound containing the metal, an organic complex of the metal, or Si having ions of the metal intercalated therein in advance.

16. The metal oxygen battery according to claim 1, wherein the electrolyte layer comprises a separator impregnated with an electrolyte solution.

17. The metal oxygen battery according to claim 16, wherein the electrolyte solution comprises at least one electrolyte solution selected from the group consisting of an electrolyte solution comprising a KOH solution and an electrolyte solution containing a salt of the metal used in the negative electrode dissolved in a nonaqueous solvent.

18. The metal oxygen battery according to claim 16, wherein the nonaqueous solvent comprises at least one nonaqueous solvent selected from the group consisting of propylene carbonate, a mixed solution of propylene carbonate and dimethyl carbonate, a mixed solution of propylene carbonate and diethyl carbonate, a mixed solution of ethylene carbonate and dimethyl carbonate, and a mixed solution of ethylene carbonate and diethyl carbonate.
